(19) United States
(12) Patent Application Publication
(10) Pub. No.: US 2015/0185803 A1
(43) Pub. Date: Jul. 2, 2015

(54) SYSTEM AND METHOD FOR DCVS HEADROOM ADJUSTMENT AND PROCESSING LEVEL OPTIMIZATION IN A SYSTEM ON A CHIP

(71) Applicant: QUALCOMM INCORPORATED, SAN DIEGO, CA (US)

(72) Inventors: Brian Jeffrey Salsbery, Superior, CO (US); Neal Countryman, Fort Collins, CO (US)

(73) Assignee: QUALCOMM INCORPORATED, SAN DIEGO, CA (US)

(21) Appl. No.: 14/144,498

(22) Filed: Dec. 30, 2013

(51) Int. Cl. G06F 1/32

(52) U.S. Cl. CPC G06F 1/324; G06F 1/3206

(57) ABSTRACT

Various embodiments of methods and systems for dynamically adjusting a command input for controlling operating frequency settings to one or more processing components are disclosed. Because a command input to a dynamic clock and voltage scaling module may dictate that operating frequency levels are unnecessarily high when a stable workload is being processed (i.e. a workload that has historically exhibited a low risk of significant fluctuation in processing capacity requirements), embodiments of a system or method for headroom adjustment and processing level optimization (“HAPLO”) may adjust the command input so that the operating frequency is optimized to a lower frequency without sacrificing delivery of an acceptable quality of service (“QoS”) to a user. Similarly, other HAPLO systems or methods may use recognition that a workload has increased from a stable level to adjust the command input such that the operating frequency is increased and a QoS level recovered or maintained.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices.

Users of PCDs demand high quality of service (“QoS”) levels. Users also desire long-lasting power supplies in their PCDs. Due to the limited form factors, however, simply including large power sources is usually not a solution for meeting a user's QoS and power supply expectations. As such, in a PCD power consumption must be managed so that a suitable QoS level is delivered to the user without wasting the PCD's limited power supply to do it.

Power consumption is managed in many PCDs through the application of one or more dynamic clock and voltage scaling (“DCVS”) algorithms that seek to balance the power consumption of processing components with the speed at which those components are capable of processing workloads (i.e., DCVS algorithms seek to optimize the QoS level delivered to a user in view of power consumption). A typical parameter that is input to a DCVS algorithm relates to the amount of processing capacity headroom that must be maintained for workload fluctuations. As such, DCVS algorithms will set power supply levels to processing components based on an amount of power needed for the processing component to process an active workload plus the required headroom that may be needed to quickly accommodate any fluctuations in the workload.

In a system with a stable workload, the set aside of a given processing capacity headroom may not be critical to ensure a suitable QoS and, in some cases, may dictate that a DCVS algorithm sets power supply levels unnecessarily high. Accordingly, what is needed in the art is a method and system for adjusting headroom so that power consumption is optimized while maintaining delivery of a suitable QoS to a user.

### SUMMARY OF THE DISCLOSURE

Various embodiments of methods and systems for dynamically adjusting a command input for controlling operating frequency settings to one or more processing components in a portable computing device (“PCD”) are disclosed. Because a command input to a dynamic clock and voltage scaling (“DCVS”) algorithm/module may dictate that operating frequency levels are unnecessarily high when a stable workload is being processed (i.e. a workload that has historically exhibited a low risk of significant fluctuation in processing capacity requirements), embodiments of a system or method for headroom adjustment and processing level optimization (“HAPLO”) may adjust the command input so that the operating frequency is optimized to a lower frequency without sacrificing delivery of an acceptable quality of service (“QoS”) to a user. Similarly, other HAPLO systems or methods may use recognition that a workload has increased from a stable level to adjust the command input such that the operating frequency is increased and a QoS level recovered or maintained.

One such HAPLO method involves monitoring a workload being processed by a processing component and determining that the workload is stable. Based on the determination that the workload is stable, the command input may be adjusted such that an operating frequency level supplied to the processing component is changed from a first level to a second level. Determining that the workload is stable may be accomplished any number of ways including, but not limited to, recognizing that a processing capacity required to process the workload over a period of time has remained within a predefined variance from a mean or recognizing that a processing capacity required to process the workload over a period of time has varied from a mean by an amount equal to or less than a standard deviation. Monitoring other statistics or parameters that may be indicative of a stable workload is envisioned.

In some embodiments of a HAPLO system or method, adjusting the command input may comprise adjusting a headroom capacity setting. Because under certain use cases a predefined, static headroom capacity may dictate that a command input to a DCVS module produces supply of an operating frequency that is higher than necessary in order to process a stable workload and maintain an acceptable QoS level, a HAPLO embodiment may adjust the headroom setting such that a lower frequency is supplied to the processing component.

Similarly, in some embodiments of a HAPLO system or method, adjusting the command input may comprise adjusting it such that a change in the operating frequency is more quickly supplied than it would be otherwise. Because under certain use cases a change in workload may impact the QoS delivered to a user if the operating frequency supplied to the processing component remains unchanged, a HAPLO embodiment may favor a step change in the command input or a dynamically adjusted filter constant, either of which may advantageously change the rate at which the destination command input value is approached. Advantageously, by making a step change adjustment or filter constant adjustment to the command input, a HAPLO embodiment may enable a DCVS module to more quickly supply an optimum operating frequency than it would otherwise do if the command input were changed in a linear fashion or per a typical single pole filter.

For HAPLO embodiments that override linear adjustments of a command input to a DCVS module in favor of a step change adjustment that more quickly drives the operating frequency to an optimum level, a determination may be made that the workload has increased relative to a stable workload determination such that a target QoS level cannot be maintained at a current operating frequency level. Based on the determination, a HAPLO embodiment may adjust the command input such that an increase in operating frequency is supplied substantially immediately.

Similarly, for HAPLO embodiments that override linear adjustments of a command input to a DCVS module in favor of a step change adjustment that more quickly drives the operating frequency to an optimum level, a determination may be made that the workload has decreased relative to a stable workload determination such that the operating frequency is higher than necessary in order for a target QoS level to be maintained. Based on the determination, a HAPLO embodiment may adjust the command input such that a decrease in operating frequency is supplied substantially immediately.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a graph illustrating an exemplary theoretical clock frequency curve and an exemplary actual clock frequency curve;

FIG. 2A is a graph illustrating an exemplary workload curve, an exemplary workload plus headroom curve representing a typical DCVS command input, and an exemplary resulting clock frequency curve dictated by a DCVS algorithm;

FIG. 2B is a graph illustrating the exemplary workload curve of FIG. 2A, an exemplary workload plus headroom curve representing a DCVS command input generated by an embodiment of a method for DCVS headroom adjustment and processing level optimization (a “HAPLO” method), and an exemplary resulting clock frequency curve dictated by a DCVS algorithm;

FIG. 3A is a graph illustrating an exemplary workload curve exhibiting a variable loading pattern, an exemplary workload plus headroom curve representing a typical DCVS command input, and an exemplary resulting clock frequency curve dictated by a DCVS algorithm;

FIG. 3B is a graph illustrating the exemplary workload curve of FIG. 3A, an exemplary workload plus headroom curve representing a DCVS command input generated by an embodiment of a HAPLO method, and an exemplary resulting clock frequency curve dictated by a DCVS algorithm;

FIG. 4 is a graph illustrating exemplary performance levels set according to a HAPLO method in response to a variable series of workloads;

FIG. 5 is a functional block diagram illustrating an embodiment of an on-chip system for DCVS headroom adjustment and processing level optimization;

FIG. 6 is a functional block diagram of an exemplary, non-limiting aspect of a PCD in the form of a wireless telephone for implementing methods and systems for DCVS headroom adjustment and processing level optimization;

FIG. 7 is a schematic diagram illustrating an exemplary software architecture of the PCD of FIG. 5 for supporting DCVS headroom adjustment and processing level optimization; and

FIG. 8 is a logical flowchart illustrating an embodiment of a method for DCVS headroom adjustment and processing level optimization.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” “processing component,” “processing engine” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphics processing unit (“GPU”),” “chip,” “video codec,” “system bus,” “image processor,” and “media display processor (“MDP”)” are non-limiting examples of processing components that are controllable through dynamic clock and voltage scaling (“DCVS”) techniques and may reside in a PCD. These terms for processing components are used interchangeably except when otherwise indicated. Moreover, as distinguished in this description, any of the above or their equivalents may be comprised of one or more distinct processing components generally referred to herein as “core(s)” and/or “sub-core(s).”

In this description, the terms “workload,” “process load,” “process workload,” and “graphical workload” are used interchangeably and generally directed toward the processing burden, or percentage of processing burden, that is associated with, or may be assigned to, a given processing component in a given embodiment. Additionally, the related terms “frame,” “code block” and “block of code” are used interchangeably to refer to a portion or segment of a given workload. For instance, a graphical workload may be comprised of a series of frames, as would be understood by one of ordinary skill in the art of video processing. Further to that which is defined above, a “processing component” or the like may be, but is not limited to being, a central processing unit, a graphical processing unit, a core, a main core, a sub-core, a processing area, a hardware engine, etc. or any component residing within, or external to, an integrated circuit within a portable computing device.

One of ordinary skill in the art will recognize that the term “MIPS” represents the number of millions of instructions per second a processor is able to process at a given power frequency. In this description, the term is used as a general unit of measure to indicate relative levels of processor performance in the exemplary embodiments and will not be construed to suggest that any given embodiment falling within the scope of this disclosure must, or must not, include a processor having any specific Dhrystone rating or processing capacity. Additionally, as would be understood by one of ordinary skill in the art, a processor's MIPS setting directly correlates with the power frequency, or operating frequency, being supplied to the processor.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

In this description, the terms “stable,” “stability,” “stable workload,” “workload stability” and the like are relative terms. That is, a workload that is considered by one HAPLO embodiment to be “stable” at a point in time may not be considered stable by the same embodiment at a different point in time. Moreover, a given HAPLO embodiment may determine that a certain amount of workload variation over a period of time qualifies as a stable workload while a different embodiment may find the same amount of workload variation over an equivalent duration to be “unstable” or “not stable enough.” In this way, it will be understood that what is, or is not, considered to be a stable workload is subjectively determined and, as such, a HAPLO embodiment will not be limited to recognizing a specific range of workload variability as indicative of workload stability.

Managing processing performance for QoS optimization in a PCD can be accomplished by dynamically adjusting processing headroom capacity so that a dynamic clock and voltage scaling (“DCVS”) algorithm drives operating frequencies to optimum levels. The dynamically adjusted processing headroom capacity may be used as an input to a DCVS algorithm to ensure that the algorithm selects the most optimum operating frequency for a given processing component. Notably, opportunities to adjust a headroom capacity may be recognized by monitoring workload variability.

Exemplary embodiments of systems and methods for DCVS headroom adjustment and processing level optimization (“HAPLO”) are described herein within the context of graphical workloads being processed by a graphical processing unit (“GPU”); however, it is envisioned that embodiments of the systems and methods may be applied to any type of workload and processing component and, as such, the scope of the disclosure is not limited to applications involving a GPU.

Embodiments of HAPLO systems and methods monitor workloads in an effort to recognize stable trends in the workloads. Advantageously, the processing requirements for stable workloads are predictable (as may be quantified any number of ways including, but not limited to, variance in processing requirements from one block of code to the next, standard deviation of processing requirements from one block of code to the next, etc.). As such, it is envisioned that the amount of processing capacity headroom may be minimized when a workload is stable from code block to code block or frame to frame.

Regardless of how a particular HAPLO embodiment quantifies workloads, the result is recognition of a stable workload over a period of time or series of frames (i.e., a sample period such as, for example, 15 frames). To this end, embodiments of HAPLO systems and methods may recognize that a workload is stable when it recognizes that variation in processing burden from code block to code block, or frame to frame, over a sample period is within an acceptable range. Notably, and as mentioned above, the exemplary HAPLO embodiments will be described within the context of a graphical workload comprised of a series of frames, such as may be associated with a video stream. It is envisioned that different sample periods will be appropriate depending on the particular HAPLO embodiment and, as such, a HAPLO embodiment will not be limited by any particular sample period or quantification thereof.

Once a workload, such as a graphical workload, is determined to be stable (i.e., the processing burden from frame to frame over a certain sample period is consistent within an acceptable tolerance), a HAPLO system and method may reduce a headroom constant such that the amount of processing requirements recognized as needed by a DCVS algorithm more closely matches the processing requirements of the stable workload. In this way, a HAPLO embodiment may set a total processing requirement (workload requirement plus headroom requirement) at a level that enables a DCVS algorithm to reduce the operating frequency level supplied to a processing component before the headroom reduction. By reducing the operating frequency level, unnecessary power consumption is reduced while maintaining the QoS.

Similarly, HAPLO systems and methods may also recognize changes in a workload, such as an increase in a workload that, up until the increase, was stable from frame to frame. Because a sudden processing burden increase in a stable workload may cause the QoS to suffer, HAPLO embodiments may maintain suitable QoS levels by causing the DCVS algorithm to increase operating frequency supplied to a processing component.

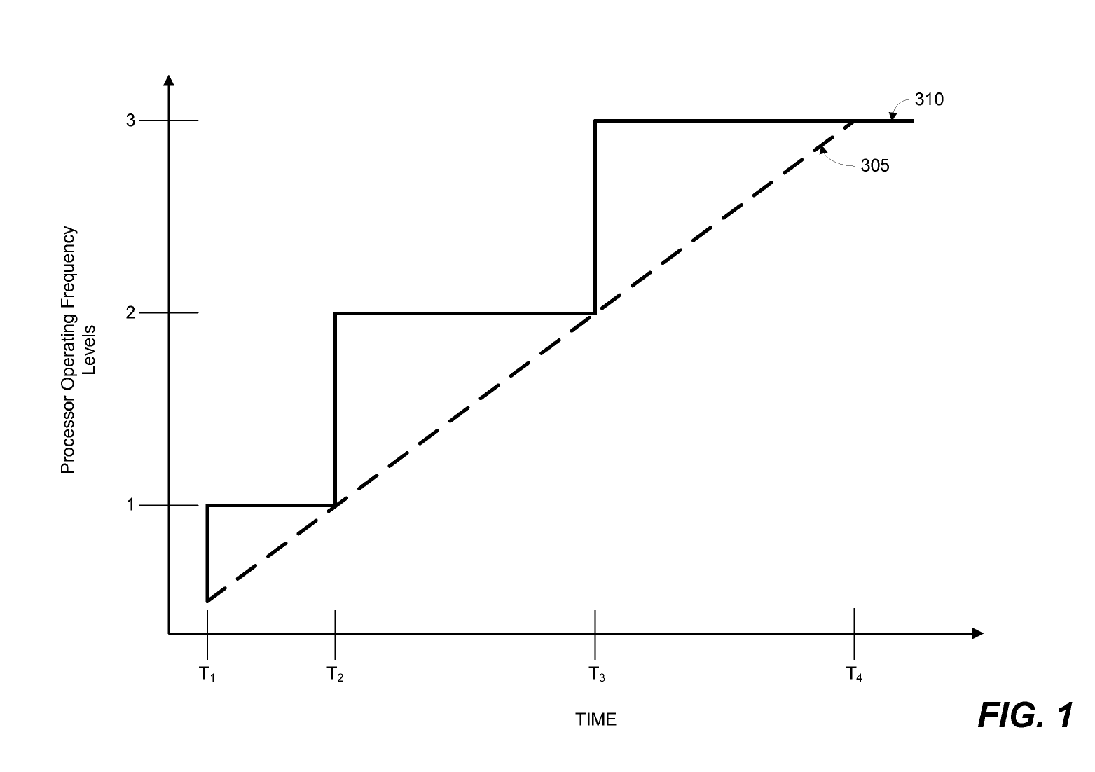

FIG. 1 is a graph illustrating an exemplary theoretical clock frequency curve 305 and an exemplary actual clock frequency curve 310. In the FIG. 1 graph, the vertical axis represents the operating frequency levels that may be supplied to a processing component, such as a GPU, per instructions from a DCVS module. Notably, the FIG. 1 graph (as well as subsequent graphs) depicts three operating frequency levels available for supply to a given processing component, however, it is envisioned that any number of operating frequency levels may be available for supply to a given processing component. The horizontal axis represents time.

As explained above, in prior art systems headroom may be a constant value that is tuned to determine the amount of extra processing performance, over and above that which is required to process an active workload, that must be maintained to ensure that unpredictable workload fluctuations are accommodated and desired QoS levels maintained. Advantageously, HAPLO systems and methods use the recognition of consistent and predictable workloads to dynamically adjust the headroom, thereby optimizing power consumption without significantly risking a sacrifice to QoS.

Returning to the FIG. 1 graph, the theoretical clock frequency curve 305 represents a correlation with the power needed to accommodate an active workload plus a headroom capacity and may be thought of as a control input to a DCVS algorithm. From the curve 305, it can be seen that the system is calling for an increase in power supply over a period of time as a workload burden is increasing. As would be understood by one of ordinary skill in the art, the system may be calling for increased power supply in order to maintain a target QoS level.

Notably, however, the system cannot deliver a linear increase in power supply consistent with the curve 305, as only a discrete number of operating frequency levels (1, 2, 3 . . . n) are available for supply to the processing component. As such, in response to a call for power supply that mirrors curve 305, a DCVS module may make step increases in the operating frequency levels as illustrated by the exemplary actual clock frequency curve 310. Therefore, as would be understood by one of ordinary skill in the art, the amount of power supplied (and consumed) between time points T₁ and T₂, T₂ and T₃, and T₃ and T₄ exceeds the amount of power actually needed to accommodate the processing burden and headroom capacity (as indicated by the command curve 305).

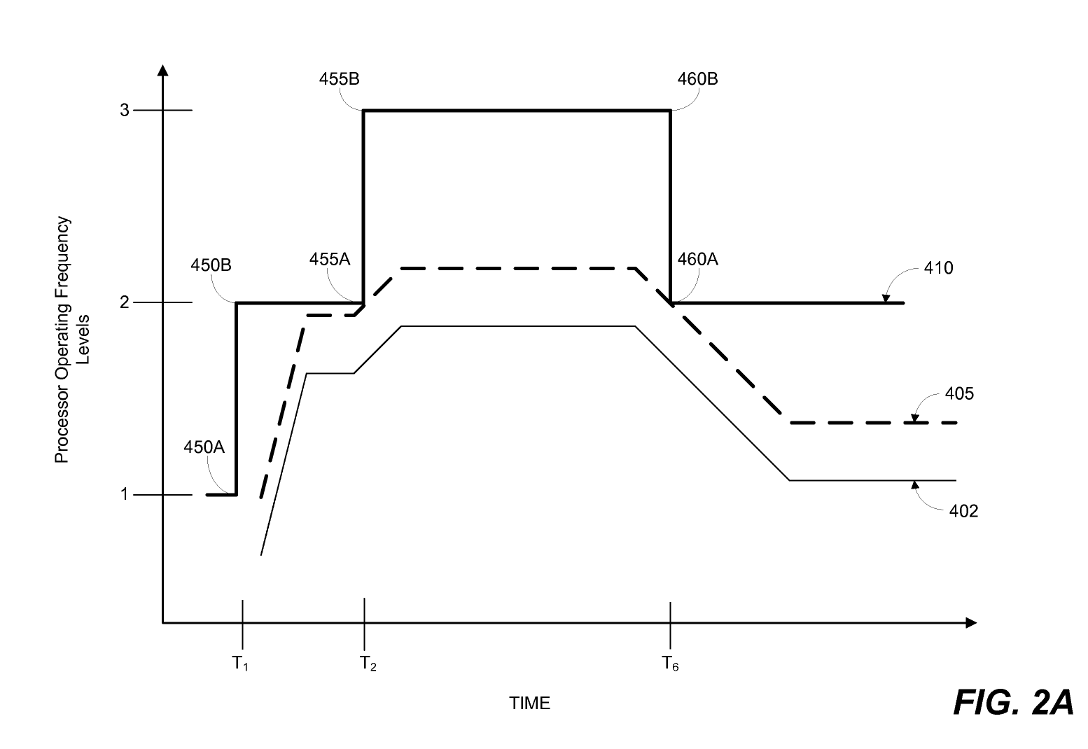

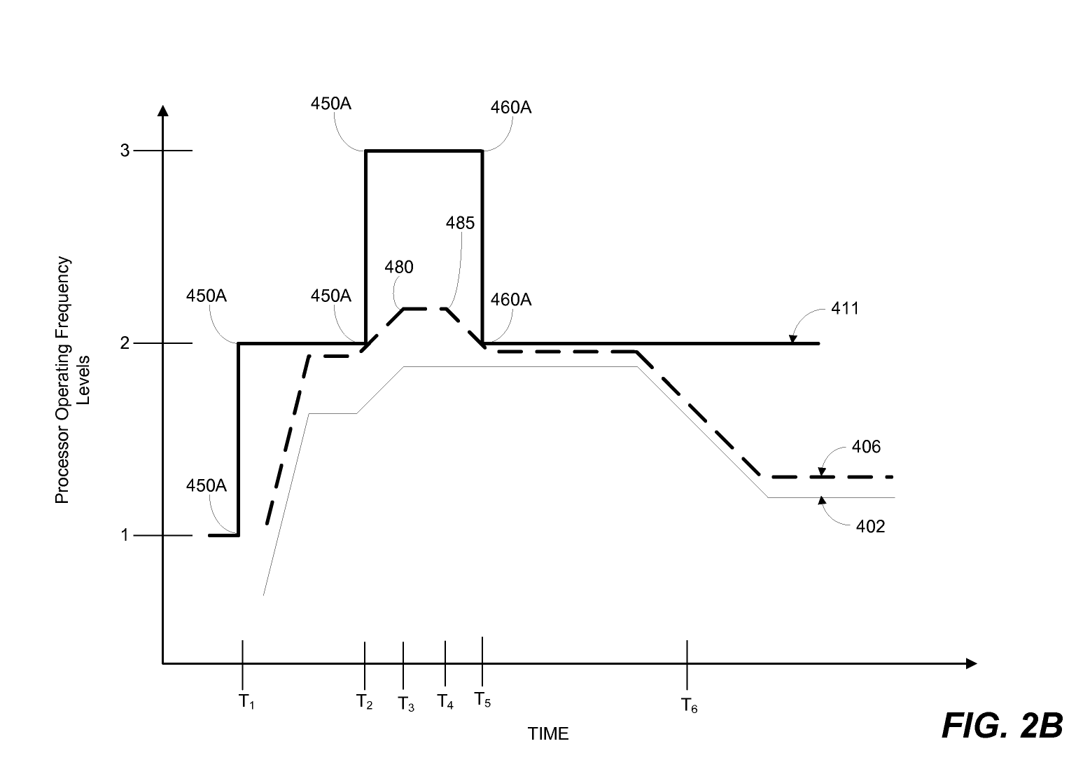

FIG. 2A is a graph illustrating an exemplary workload curve 402, an exemplary workload plus headroom curve 405 representing a typical DCVS command input, and an exemplary resulting clock frequency curve 410 dictated by a DCVS algorithm. The uppermost curve 410 plots the operating frequency that may be supplied to an exemplary processor in response to the DCVS command input 405. As in the FIG. 1 graph, in the FIG. 2A graph the vertical axis represents the operating frequency levels that may be supplied to a processing component, such as a GPU, per instructions from a DCVS module and the horizontal axis represents time.

One of ordinary skill in the art will recognize that the processor operating frequency correlates with a number of MIPS capable of being processed by the given processor over a period of time. Similarly, one of ordinary skill in the art will also recognize that the workload curve 402 correlates with an actual number of MIPS that must be processed by the given processor over a period of time in order that a target QoS level is met. Therefore, for the target QoS level dictated by workload curve 402 to be met or exceeded, clock frequency curve 410 must correlate with operating frequency levels that at any point in time exceed the processing requirements dictated by workload curve 402.

With the above in mind, it can be understood from the FIG. 2A graph that clock frequency curve 410 must also correlate with operating frequency levels that at any point in time exceed the processing requirements dictated by workload plus headroom curve 405. In this way, a DCVS algorithm that drives clock frequency curve 410 ensures that there is always enough power being supplied to the processor to accommodate at a given performance level the workload processing requirements of workload curve 402 plus the additional headroom requirements included in curve 405.

A DCVS algorithm may determine the shape of clock frequency curve 410 based on a command input that mirrors workload plus headroom curve 405. Referring to the FIG. 2A illustration, at time T₁ clock frequency curve 410 increases the operating frequency supplied to the given processor from level 1 to level 2 (point 450). The increase in the supplied operating frequency may have been in response to the workload plus headroom curve 405 indicating that at time T₁ the required processing power needed to maintain a target QoS is in excess of the level 1 operating frequency.

Between times T₁ and T₂, the workload plus headroom curve 405 dictates a total required power supply level that is less than the level 2 operating frequency and, accordingly, the DCVS algorithm maintains the processor performance level by holding the power supply level at the level 2 operating frequency up until time T₂. Notably, in the exemplary FIG. 2A graph, the workload plus headroom curve 405 dictates that the total required processing power from time T₂ to T₆ is in excess of the level 2 operating frequency. Therefore, at time T₂ the DCVS algorithm increases clock frequency curve 410 from level 2 to level 3 (point 455) and maintains that operating frequency until time T₆ when the total required processing power indicated by workload plus headroom curve 405 drops below the level 2 operating frequency (point 460).

Notably, it can be seen in the FIG. 2A illustration that the actual workload as indicated by workload curve 402 could be processed by the given processor with an operating frequency level supplied to it at level 2. As such, between times T₂ and T₆, the DCVS algorithm was driven to supply power to the processing component at a level 3 operating frequency in order to ensure that the headroom capacity included in workload plus headroom curve 405 was maintained.

FIG. 2B is a graph illustrating the exemplary workload curve 402 of FIG. 2A, an exemplary workload plus headroom curve 406 representing a DCVS command input generated by an embodiment of a method for DCVS headroom adjustment and processing level optimization (a “HAPLO” method), and an exemplary resulting clock frequency curve 411 dictated by a DCVS algorithm. Advantageously, embodiments of HAPLO systems and methods recognize opportunities to reduce headroom capacity so that operating frequency levels delivered by a DCVS algorithm may be optimized. For example, an embodiment of a HAPLO system and method may dynamically adjust the headroom included in curve 405 such that a DCVS algorithm returns the supplied operating frequency from level 3 to level 2 before time T₆, as indicated in workload plus headroom curve 406. By recognizing that the supplied operating frequency in the FIG. 2A illustration may be returned to level 2 before time T₆, a HAPLO system and method may avoid unnecessary power consumption without sacrificing QoS delivered to a user.

Returning to the exemplary FIG. 2B graph, the workload plus headroom curve 406 mirrors that of workload plus headroom curve 405 in FIG. 2A up until time T₄ (point 485). Advantageously, from time T₃ to T₄ a HAPLO embodiment may have recognized that the workload of curve 402 was stable and/or predictable to such an extent that the amount of headroom included curve 405, 406 was unnecessary in order to maintain a target QoS. As such, at point 485 the exemplary HAPLO embodiment reduces the amount of set aside headroom included in curve 406 such that the DCVS algorithm reduces the supplied operating frequency back down to the exemplary level 2 at time T₅ (point 457). By doing so, the exemplary HAPLO system and method avoided the unnecessary consumption of power at the level 3 operating frequency from time T₅ to time T₆.

For example, certain embodiments of HAPLO systems and methods may recognize a stable workload as a graphics based workload where the required processing capacity from frame to frame over a certain period of time has remained consistent. The consistency may be quantified, for example, by a variance or standard deviation statistic from frame to frame over the period of time, although other parameters for quantifying workload stability are envisioned.

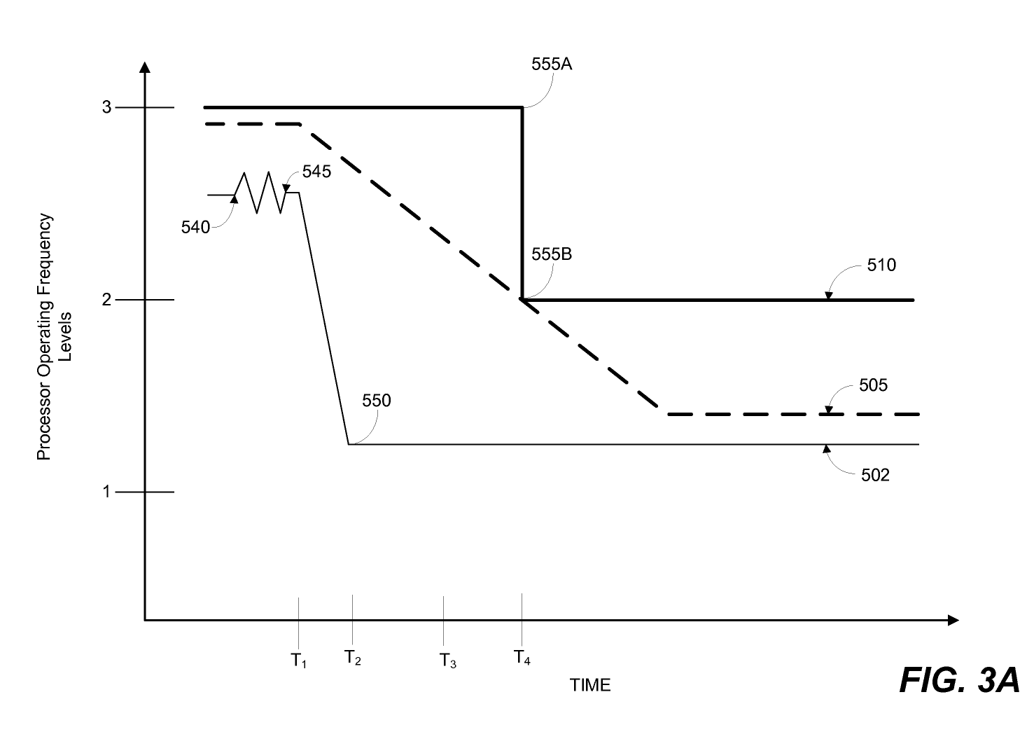

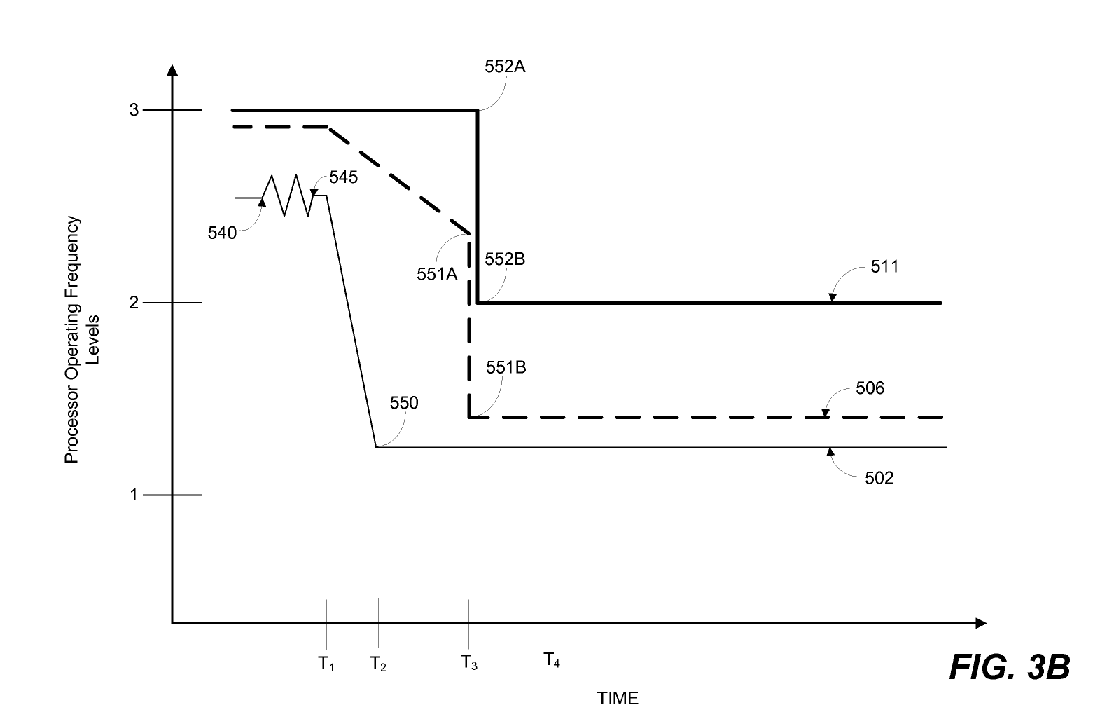

FIG. 3A is a graph illustrating an exemplary workload curve 502 exhibiting a variable loading pattern, an exemplary workload plus headroom curve 505 representing a typical DCVS command input, and an exemplary resulting clock frequency curve 510 dictated by a DCVS algorithm. Similar to that which was depicted and described relative to FIGS. 2A-2B, the workload plus headroom curve 505 may be used as an input to a DCVS algorithm so that an operating frequency level capable of delivering or exceeding a target QoS is supplied to a processor tasked with processing the workload represented by curve 502.

As can be seen in the FIG. 3A illustration, the actual workload represented by curve 502 is initially unstable before it drops quickly at time T₁ and stabilizes starting at time T₂. There is a significant amount of time between time T₂ when the workload processing requirements stabilizes (point 550) and time T₄ when the supplied operating frequency level is reduced from level 3 to level 2 (point 555). As explained above, the duration for which the supplied operating frequency is at a level that is higher than necessary to accommodate the actual workload and a reasonable headroom capacity represents an opportunity for power savings.

Simply increasing the reduction rate of, or adjusting the filter constant of, the command input (curve 505) to the DCVS algorithm may risk delivery of an unacceptable QoS level in the event that a variable loading pattern is experienced (such as, for example, between points 540 and 545). Therefore, embodiments of a HAPLO system and method may monitor the actual workload 502 in an effort to recognize when the workload has stabilized and the risk of workload fluctuations is low. Advantageously, by recognizing workload stability, a HAPLO system and method may conserve power by more quickly returning a supplied operating frequency to a lower level.

FIG. 3B is a graph illustrating the exemplary workload curve 502 of FIG. 3A, an exemplary workload plus headroom curve 506 representing a DCVS command input generated by an embodiment of a HAPLO system and method, and an exemplary resulting clock frequency curve 511 dictated by a DCVS algorithm. Advantageously, embodiments of HAPLO systems and methods recognize opportunities to make step changes in DCVS command inputs (or, otherwise adjust the rate of change in DCVS command inputs) that are indicative of workload plus headroom requirements. By making the quick step or rate changes in lieu of simply systematically reducing the command input at a predefined rate, the operating frequency levels delivered by a DCVS algorithm may be optimized.

For example, an embodiment of a HAPLO system and method may dynamically adjust the shape of command input curve 505 such that a DCVS algorithm returns the supplied operating frequency from level 3 to level 2 before time T₄, as indicated in command input curve 506. By recognizing that the supplied operating frequency in the FIG. 3A illustration may be returned to level 2 before time T₄, a HAPLO system and method may avoid unnecessary power consumption without sacrificing QoS delivered to a user.

Returning to the exemplary FIG. 3B graph, the DCVS command input curve 506 mirrors that of command input curve 505 in FIG. 3A up until time T₃ (point 551). Advantageously, from time T₂ to T₃ a HAPLO embodiment may have recognized that the workload of curve 502 was stable and/or predictable to such an extent that a step change in the command input could be implemented without risking an unacceptable QoS. As such, at point 551 the exemplary HAPLO embodiment significantly modifies command curve 505 of FIG. 3A such that the total workload plus headroom processing capacity drops to a level that is within the level 2 operating frequency. In response, the DCVS algorithm may immediately reduce the supplied operating frequency back down to the exemplary level 2 shortly following time T₃ (point 552). By doing so, the exemplary HAPLO system and method avoided the unnecessary consumption of power at the level 3 operating frequency from time T₃ to time T₄.

For example, certain embodiments of HAPLO systems and methods may recognize a stable workload as a graphics based workload where the required processing capacity from frame to frame over a certain period of time has remained consistent. The consistency may be quantified, for example, by a variance or standard deviation statistic from frame to frame over the period of time, although other parameters for quantifying workload stability are envisioned.

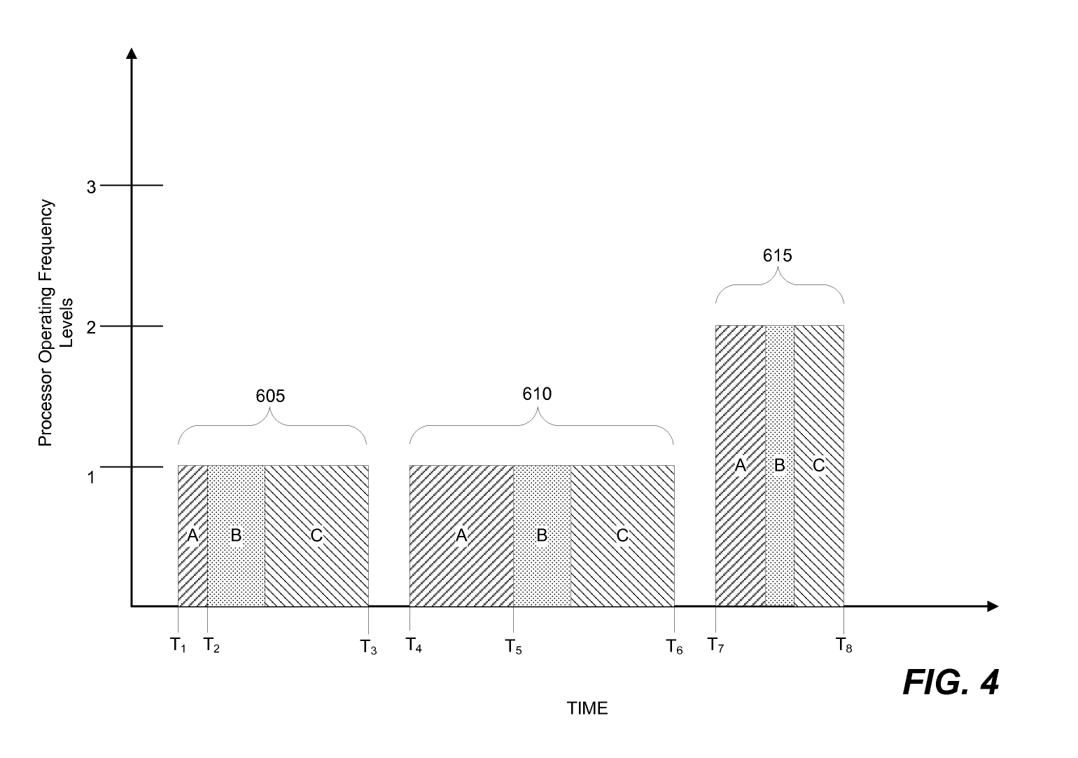

FIG. 4 is a graph illustrating exemplary performance levels set according to an exemplary HAPLO system and method in response to a variable series of workloads 605, 610, 615. In the FIG. 4 illustration, each workload 605, 610, 615 is an aggregate of three sub-loads A, B and C. For exemplary purposes, the series of workloads 605, 610, 615 may be thought of as time-ordered frames in a graphic workload, although other types of workloads are envisioned. Also, for illustrative purposes, sub-loads A, B and C of frame 605 are on the order of 20 MIPS, 40 MIPS and 75 MIPS, respectively. For frames 610 and 615, sub-loads A, B and C are on the order of 75 MIPS, 40 MIPS and 75 MIPS, respectively. The time gaps between processing the frames may be considered processing headroom present for accommodating increases in sub-loads from frame to frame, such as can be seen in sub-load A from frame 605 to frame 610.

From the FIG. 4 illustration, it can be seen that sub-load A of frame 605 is processed from time T1 to T2 and that the entire frame 605 is processed from time T1 to time T3. As would be understood by one of ordinary skill in the art, the total workload represented by frame 605 may be processed in a time shorter in duration than T1 to T3 if the operating frequency were set higher than the level 1 operating frequency depicted in the illustration. Notably, however, a DCVS module may have set the operating frequency to level 1 based on the recognition that processing frame 605 over a duration from T1 to T3 delivers an acceptable QoS.

Returning to the FIG. 4 illustration, the sub-load A experiences a step increase in the amount of processing capacity required from 20 MIPS to 75 MIPS. As such, if the operating frequency level stays at level 1, the duration required to process the frame 610 may take from time T4 to time T6. Recognizing that duration T4 to T6 is too long in order to maintain a target QoS, a typical DCVS system may respond by gradually increasing a command input until step increases in the supplied operating frequency brings QoS back to target. Other typical DCVS systems and methods may simply increase the supplied operating frequency to a maximum level and then systematically reduce the frequency until an optimum frequency is found (thus, unnecessarily consuming power until the optimum frequency is determined). Advantageously, a HAPLO system and method may recognize the increase in sub-load A from frame 605 (and previous frames not shown) and modify the DCVS command input such that an optimum operating frequency is immediately delivered. In this way, target QoS levels may be quickly recovered and maintained in response to a change in workload requirements.

In the example, at time T5 a HAPLO system and method may recognize that sub-load A has increased from 20 MIPS to 75 MIPS. Some HAPLO embodiments may immediately cause an increase in the operating frequency level while others may make the increase after frame 610 has been completely processed. Regardless, HAPLO embodiments use determination of a stable workload to recognize when workloads have increased or decreased beyond an acceptable amount of variation. Based on the recognized change, HAPLO embodiments may determine a change in supplied operating frequency in order to recover or maintain a target QoS level.

Returning to the FIG. 4 example, a HAPLO system and method may respond to the increase in exemplary sub-load A by causing a step increase in operating frequency level from the exemplary level 1 to the exemplary level 2. By doing so, the frame 615 may be completely process in a duration from time T7 to T8 which is commensurate with a QoS level at or exceeding a target QoS level.

The FIG. 4 illustration has been explained within the context of an example that includes an increase in processing requirements from one frame to the next. It is envisioned, however, that a similar HAPLO method may use determination of a stabilized workload pattern to recognize decreases in workload requirements and quickly effect step changes in operating frequencies to lower levels. In this way, HAPLO embodiments may avoid unnecessary power consumption to process workloads that could otherwise be processed at lower operating frequencies without sacrificing QoS. It is also envisioned that HAPLO embodiments may cause increases or decreases in operating frequency levels multiple levels at a time and, as such, the description of the FIG. 4 illustration within the context of a single operating frequency level increase from frame 610 to 615 will not limit the scope of this disclosure.

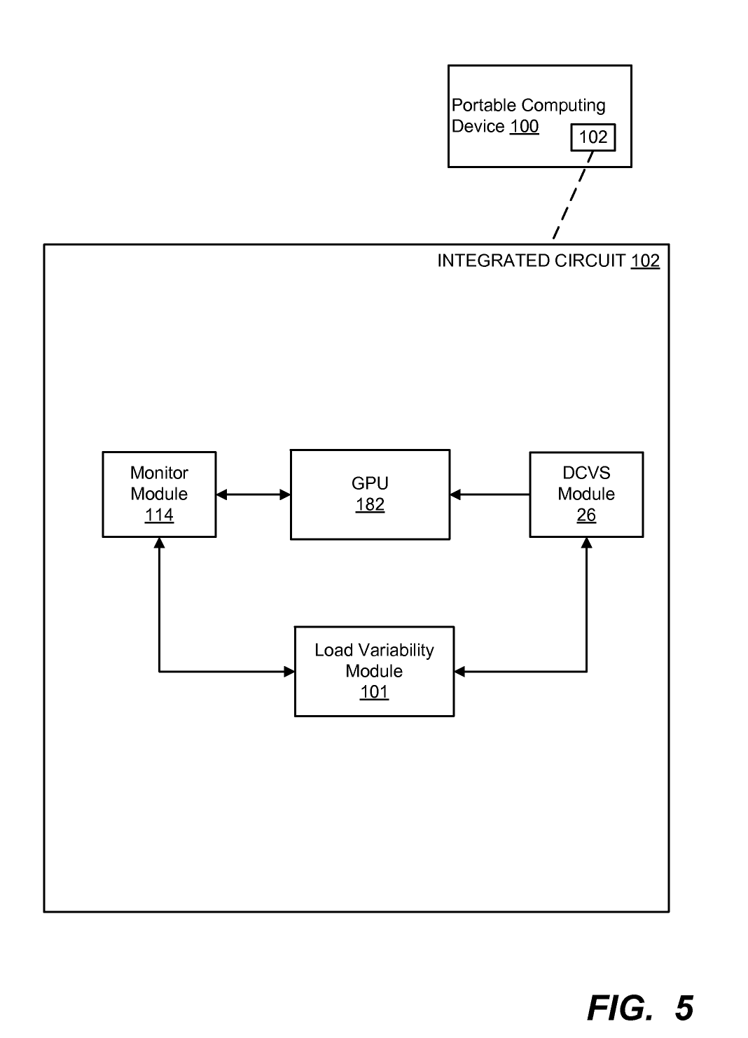

FIG. 5 is a functional block diagram illustrating an embodiment of an on-chip system 102 for DCVS headroom adjustment and processing level optimization (“HAPLO”). As explained above relative to the FIGS. 1-4 illustrations, HAPLO systems monitor workload patterns to recognize stable runs in the workloads. Based on the recognition of a stable workload, HAPLO embodiments may adjust headroom capacity in a DCVS command input so that lower and more optimum operating frequencies are supplied to a given processing component. Other HAPLO embodiments may use determination of a stable workload to recognize opportunities for immediate step changes in a DCVS command input such that a supplied operating frequency level is immediately adjusted to a more optimum level, thereby avoiding slow reductions in a command that delay an inevitable operating frequency change.

The on-chip system 102 may monitor workloads with a monitor module 114 that is in communication with a load variability (“LV”) module 101. The LV module 101 may receive workload variability measurements from the monitor module 114 and use the variability data to determine when a workload is stable. Notably, the monitor module 114 is depicted in the FIG. 5 illustration as monitoring a processing component in the form of a GPU 182, although other processing component types (and, consequently, workload types) are envisioned.

Based on the workload variability data, the LV module 101 may recognize changes in the workload that present opportunities for modifying a command input to the DCVS module 26, as described above. The DCVS module 26 responds to the modified command input from the LV module 101 by adjusting processor clock speeds. Notably, adjusting or modifying a DCVS command input based on analysis of workload variability, the LV module 101 may reduce or alleviate unnecessary power consumption without sacrificing QoS.

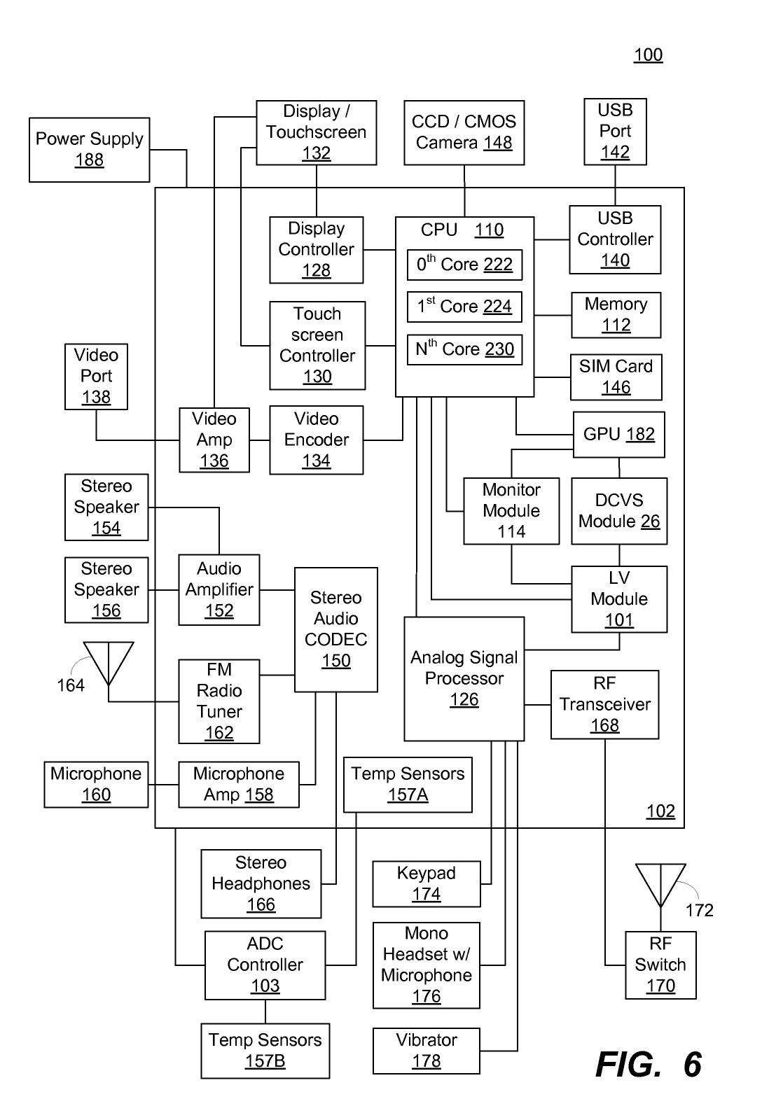

FIG. 6 is a functional block diagram of an exemplary, non-limiting aspect of a PCD 100 in the form of a wireless telephone for implementing methods and systems for DCVS headroom adjustment and processing level optimization (“HAPLO”). As shown, the PCD 100 includes an on-chip system 102 that includes a heterogeneous multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art. Moreover, as is understood in the art of heterogeneous multi-core processors, each of the cores 222, 224, 230 may process workloads at different efficiencies under similar operating conditions.

In general, the load variability module(s) 101 may receive data indicative of workload variability in one or more processing components and use the data to recognize opportunities for modification of a DCVS command input. By modifying the DCVS command input based on workload variability statistics, LV modules 101 may conserve power supplies without sacrificing QoS. The monitor module 114 may communicate with multiple processing components distributed throughout the on-chip system 102 and with the CPU 110 of the PCD 100 as well as with the LV module(s) 101.

As illustrated in FIG. 6, a display controller 128 and a touchscreen controller 130 are coupled to the digital signal processor 110. A touchscreen display 132 external to the on-chip system 102 is coupled to the display controller 128 and the touchscreen controller 130.

PCD 100 may further include a video decoder 134, e.g., a phase-alternating line (“PAL”) decoder, a sequential couleur avec memoire (“SECAM”) decoder, a national television system(s) committee (“NTSC”) decoder or any other type of video decoder 134. The video decoder 134 is coupled to the multi-core central processing unit (“CPU”) 110. A video amplifier 136 is coupled to the video decoder 134 and the touchscreen display 132. A video port 138 is coupled to the video amplifier 136. As depicted in FIG. 6, a universal serial bus (“USB”) controller 140 is coupled to the CPU 110. Also, a USB port 142 is coupled to the USB controller 140. A memory 112 and a subscriber identity module (SIM) card 146 may also be coupled to the CPU 110. Further, as shown in FIG. 6, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 6, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 6 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 6 further indicates that a radio frequency (“RF”) transceiver 168 may be coupled to the analog signal processor 126. An RF switch 170 may be coupled to the RF transceiver 168 and an RF antenna 172. As shown in FIG. 6, a keypad 174 may be coupled to the analog signal processor 126. Also, a mono headset with a microphone 176 may be coupled to the analog signal processor 126. Further, a vibrator device 178 may be coupled to the analog signal processor 126. FIG. 6 also shows that a power supply 180, for example a battery, is coupled to the on-chip system 102. In a particular aspect, the power supply includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller 103. However, other types of thermal sensors 157 may be employed without departing from the scope of the invention.

The LV module(s) 101 may comprise software which is executed by the CPU 110. However, the LV module(s) 101 may also be formed from hardware and/or firmware without departing from the scope of the invention. The LV module(s) 101 may be responsible for modifying command inputs to a DCVS module 26 based on workload variability parameters monitored by the monitor module 114.

Returning to FIG. 6, the touchscreen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, and the power supply 180 are external to the on-chip system 102. However, it should be understood that the monitor module 114 may also receive one or more indications or signals from one or more of these external devices by way of the analog signal processor 126 and the CPU 110 to aid in the real time management of the resources operable on the PCD 100.

In a particular aspect, one or more of the method steps described herein may be implemented by executable instructions and parameters stored in the memory 112 that form the one or more LV module(s) 101. These instructions that form the LV module(s) 101 may be executed by the CPU 110, the analog signal processor 126, or another processor, in addition to the ADC controller 103 to perform the methods described herein. Further, the processors 110, 126, the memory 112, the instructions stored therein, or a combination thereof may serve as a means for performing one or more of the method steps described herein.

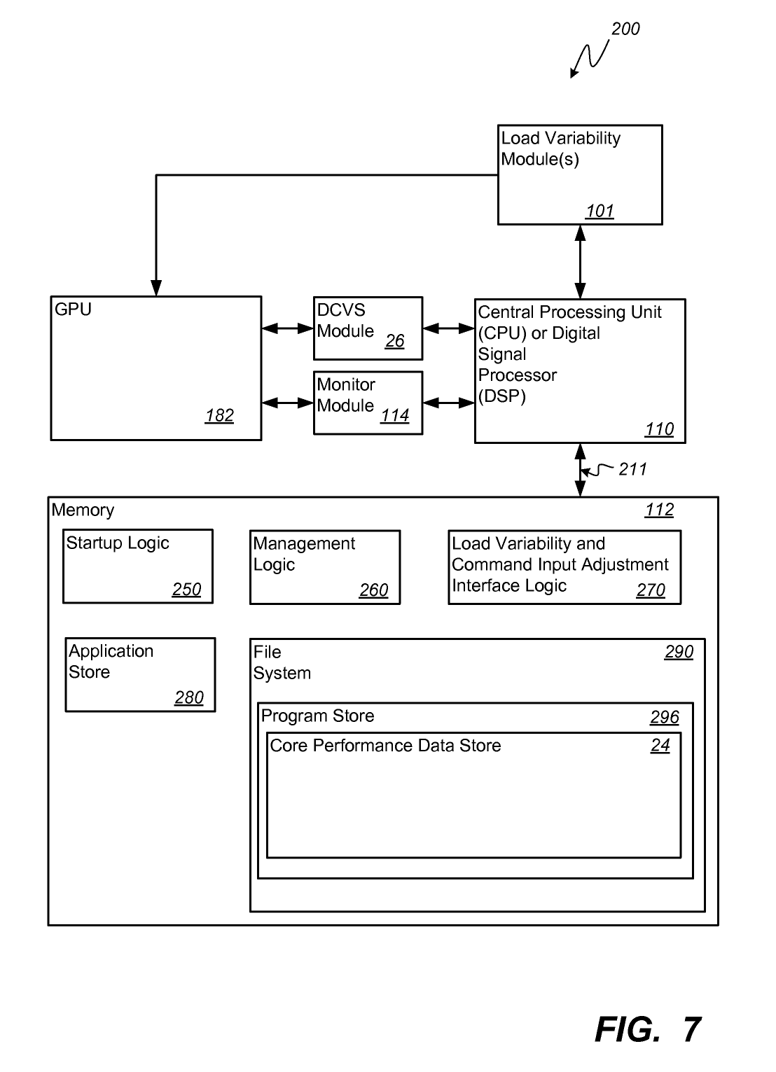

FIG. 7 is a schematic diagram illustrating an exemplary software architecture of the PCD of FIG. 6 for supporting DCVS headroom adjustment and processing level optimization (“HAPLO”). Any number of algorithms may form or be part of at least one HAPLO method that may be applied by the LV module 101 when certain workload stability statistics or parameters are recognized.

As illustrated in FIG. 7, the CPU or digital signal processor 110 is coupled to the memory 112 via a bus 211. The CPU 110, as noted above, may be a multiple-core, heterogeneous processor having N core processors. That is, the CPU 110 may include a first core 222, a second core 224, and an N^{th} core 230. As is known to one of ordinary skill in the art, each of the first core 222, the second core 224 and the N^{th} core 230 are available for supporting a dedicated application or program and, as part of a heterogeneous core, may provide differing levels of performance under similar thermal operating conditions. Alternatively, one or more applications or programs can be distributed for processing across two or more of the available heterogeneous cores.

The CPU 110 may receive commands from the LV module(s) 101 that may comprise software and/or hardware. If embodied as software, the LV module 101 comprises instructions that are executed by the CPU 110 that issues commands to other application programs being executed by the CPU 110 and other processors.

The first core 222, the second core 224 through to the Nth core 230 of the CPU 110 may be integrated on a single integrated circuit die, or they may be integrated or coupled on separate dies in a multiple-circuit package. Designers may couple the first core 222, the second core 224 through to the N^{th} core 230 via one or more shared caches and they may implement message or instruction passing via network topologies such as bus, ring, mesh and crossbar topologies.

Bus 211 may include multiple communication paths via one or more wired or wireless connections, as is known in the art. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

When the logic used by the PCD 100 is implemented in software, as is shown in FIG. 7, it should be noted that one or more of startup logic 250, management logic 260, load variability and command input adjustment interface logic 270, applications in application store 280 and portions of the file system 290 may be stored on any computer-readable medium for use by or in connection with any computer-related system or method.

In the context of this document, a computer-readable medium is an electronic, magnetic, optical, or other physical device or means that can contain or store a computer program and data for use by or in connection with a computer-related system or method. The various logic elements and data stores may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of the startup logic 250, management logic 260 and perhaps the load variability and command input adjustment interface logic 270 are implemented in hardware, the various logic may be implemented with any or a combination of the following technologies, which are each well known in the art: a discrete logic circuit(s) having logic gates for implementing logic functions upon data signals, an application specific integrated circuit (“ASIC”) having appropriate combinational logic gates, a programmable gate array(s) (“PGA”), a field programmable gate array (“FPGA”), etc.

The memory 112 is a non-volatile data storage device such as a flash memory or a solid-state memory device. Although depicted as a single device, the memory 112 may be a distributed memory device with separate data stores coupled to the digital signal processor (or additional processor cores).

The startup logic 250 includes one or more executable instructions for selectively identifying, loading, and executing a select program for load variability and command input adjustment. The management logic 260 includes one or more executable instructions for terminating a load variability analysis and command input adjustment program, as well as selectively identifying, loading, and executing a more suitable replacement program. The management logic 260 is arranged to perform these functions at run time or while the PCD 100 is powered and in use by an operator of the device. A replacement program can be found in the program store 296 of the embedded file system 290.

The replacement program, when executed by one or more of the core processors in the digital signal processor, may operate in accordance with one or more signals provided by the LV module 101. In this regard, the modules 114 may provide one or more indicators of load variability in response to control signals originating from the LV module 101.

The interface logic 270 includes one or more executable instructions for presenting, managing and interacting with external inputs to observe, configure, or otherwise update information stored in the embedded file system 290. In one embodiment, the interface logic 270 may operate in conjunction with manufacturer inputs received via the USB port 142. These inputs may include one or more programs to be deleted from or added to the program store 296. Alternatively, the inputs may include edits or changes to one or more of the programs in the program store 296. Moreover, the inputs may identify one or more changes to, or entire replacements of one or both of the startup logic 250 and the management logic 260.

The interface logic 270 enables a manufacturer to controllably configure and adjust an end user's experience under defined operating conditions on the PCD 100. When the memory 112 is a flash memory, one or more of the startup logic 250, the management logic 260, the interface logic 270, the application programs in the application store 280 or information in the embedded file system 290 can be edited, replaced, or otherwise modified. In some embodiments, the interface logic 270 may permit an end user or operator of the PCD 100 to search, locate, modify or replace the startup logic 250, the management logic 260, applications in the application store 280 and information in the embedded file system 290. The operator may use the resulting interface to make changes that will be implemented upon the next startup of the PCD 100. Alternatively, the operator may use the resulting interface to make changes that are implemented during run time.

The embedded file system 290 includes a hierarchically arranged core performance data store 24. In this regard, the file system 290 may include a reserved section of its total file system capacity for the storage of information associated with the processing capabilities of one or more processing components in the PCD 100 (such as GPU 182) that may receive operating frequency supply changes based on workload variability.

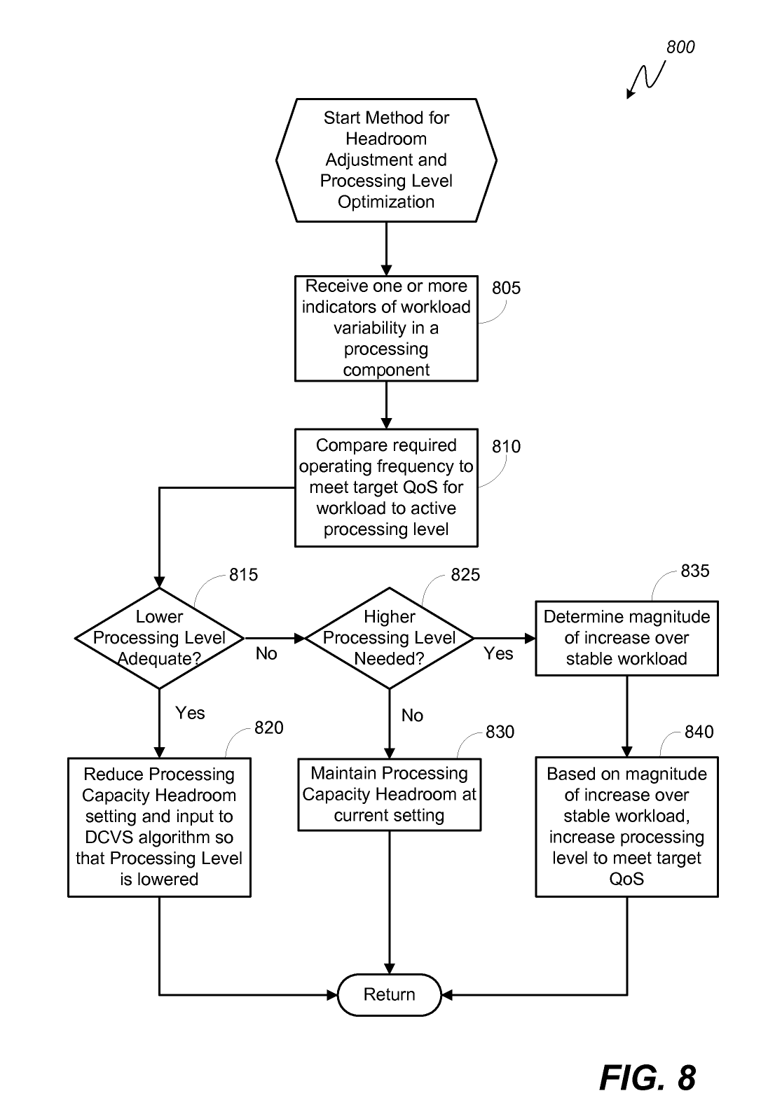

FIG. 8 is a logical flowchart illustrating an embodiment of a method 800 for DCVS headroom adjustment and processing level optimization (“HAPLO”). Beginning at block 805, an LV module 101 may work with a monitor module 114 (it is envisioned that the LV module 101 and monitor module 114 may be one and the same module in some embodiments of a HAPLO system) to recognize one or more indicators of a stable workload in a processing component, such as a GPU 182. As described above, any number of parameters or statistics may be monitored in an effort to recognize that a workload has stabilized and that the processing requirements are predictable. At block 810, the required operating frequency needed for the processing component to process the stable workload and meet or exceed a target QoS level is compared to the active operating frequency being supplied to the processing component.

At decision block 815, if a lower operating frequency could be supplied to the processing component without sacrificing QoS delivered to the user, the “yes” branch is followed to block 820. At block 820, the headroom capacity may be adjusted down such that a command input to a DCVS algorithm drives the operating frequency to the lower level determined at decision block 815 and the method 800 returns. If, however, at decision block 815 it is determined that the processing component could not process the workload according to a target QoS if the currently supplied operating frequency were lowered, then the method follows the “no” branch to decision block 825.

At decision block 825, the method may determine whether a higher operating frequency should be supplied to the processing component in order to recover or maintain a target QoS level. If a higher operating frequency is not needed in order to process the workload and maintain a target QoS, then the “no” branch is followed to block 830 and the current operating frequency is maintained. The method 800 returns.

If, however, at decision block 825 it is determined that in order to meet or exceed a target QoS the supplied operating frequency should be increased, then the “yes” branch is followed to block 835.

At block 835, the magnitude of increase in the workload over the stable workload determined at block 805 is calculated. Based on the increase in workload, at block 840 an increase in the operating frequency level may be determined and a command input to a DCVS module adjusted accordingly. The method 800 returns.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for dynamically adjusting a command input for controlling operating frequency settings to one or more processing components in a portable computing device (“PCD”), the method comprising:
monitoring a workload being processed by a processing component;
determining that the workload is stable; and
based on the determination that the workload is stable, adjusting the command input, wherein adjusting the command input causes an operating frequency level supplied to the processing component to be changed from a first level to a second level.

2. The method of claim 1, wherein determining that the workload is stable comprises recognizing that a processing capacity required to process the workload over a period of time has remained within a predefined variance from a mean.

3. The method of claim 1, wherein determining that the workload is stable comprises recognizing that a processing capacity required to process the workload over a period of time has varied from a mean by an amount equal to or less than a standard deviation.

4. The method of claim 1, wherein adjusting the command input comprises adjusting a headroom capacity setting.

5. The method of claim 1, further comprising:
determining that the workload has increased relative to the stable workload determination such that a quality of service (“QoS”) level cannot be maintained at the first operating frequency level; and
wherein the second operating frequency level is a higher operating frequency level than the first operating frequency level.

6. The method of claim 1, further comprising:
determining that the workload has decreased relative to the stable workload determination such that a quality of service (“QoS”) level can be met at the second operating frequency level; and
wherein the second operating frequency level is a lower operating frequency level than the first operating frequency level.

7. The method of claim 1, wherein the command input is to a dynamic clock and voltage scaling (“DCVS”) algorithm.

8. A computer system for dynamically adjusting a command input for controlling operating frequency settings to one or more processing components in a portable computing device (“PCD”), the computer system comprising:
means for monitoring a workload being processed by a processing component;
means for determining that the workload is stable; and
based on the determination that the workload is stable, means for adjusting the command input, wherein adjusting the command input causes an operating frequency level supplied to the processing component to be changed from a first level to a second level.

9. The computer system of claim 8, wherein the means for determining that the workload is stable comprises means for recognizing that a processing capacity required to process the workload over a period of time has remained within a predefined variance from a mean.

10. The computer system of claim 8, wherein the means for determining that the workload is stable comprises means for recognizing that a processing capacity required to process the workload over a period of time has varied from a mean by an amount equal to or less than a standard deviation.

11. The computer system of claim 8, wherein the means for adjusting the command input comprises means for adjusting a headroom capacity setting.

12. The computer system of claim 8, further comprising:
means for determining that the workload has increased relative to the stable workload determination such that a quality of service (“QoS”) level cannot be maintained at the first operating frequency level; and
wherein the second operating frequency level is a higher operating frequency level than the first operating frequency level.

13. The computer system of claim 8, further comprising:
means for determining that the workload has decreased relative to the stable workload determination such that a quality of service (“QoS”) level can be met at the second operating frequency level; and
wherein the second operating frequency level is a lower operating frequency level than the first operating frequency level.

14. The computer system of claim 8, wherein the command input is to a dynamic clock and voltage scaling (“DCVS”) algorithm.

15. A computer program product comprising a computer usable device having a computer readable program code embodied therein, said computer readable program code adapted to be executed to implement a method for dynamically adjusting a command input for controlling operating frequency settings to one or more processing components in a portable computing device (“PCD”), said method comprising:
monitoring a workload being processed by a processing component;
determining that the workload is stable; and
based on the determination that the workload is stable, adjusting the command input, wherein adjusting the command input causes an operating frequency level supplied to the processing component to be changed from a first level to a second level.

16. The computer program product of claim 15, wherein determining that the workload is stable comprises recognizing that a processing capacity required to process the workload over a period of time has remained within a predefined variance from a mean.

17. The computer program product of claim 15, wherein determining that the workload is stable comprises recognizing that a processing capacity required to process the workload over a period of time has varied from a mean by an amount equal to or less than a standard deviation.

18. The computer program product of claim 15, wherein adjusting the command input comprises adjusting a headroom capacity setting.

19. The computer program product of claim 15, further comprising:
determining that the workload has increased relative to the stable workload determination such that a quality of service (“QoS”) level cannot be maintained at the first operating frequency level; and
wherein the second operating frequency level is a higher operating frequency level than the first operating frequency level.

20. The computer program product of claim 15, further comprising:
determining that the workload has decreased relative to the stable workload determination such that a quality of service (“QoS”) level can be met at the second operating frequency level; and
wherein the second operating frequency level is a lower operating frequency level than the first operating frequency level.
